(19) United States
(12) Patent Application Publication
(10) Pub. No.: US 2024/0280240 A1
(43) Pub. Date: Aug. 22, 2024

(54) AIRCRAFT LAMP

(71) Applicant: KOITO MANUFACTURING CO., LTD., Tokyo (JP)

(72) Inventor: Takashi YODA, Shizuoka-shi (JP)

(73) Assignee: KOITO MANUFACTURING CO., LTD., Tokyo (JP)

(21) Appl. No.: 18/439,136

(22) Filed: Feb. 12, 2024

(30) Foreign Application Priority Data
Feb. 17, 2023 (JP) 2023-023249

(51) Int. Cl. F21V 5/00; B64D 11/00; F21W 107/30; F21Y 113/10

(52) U.S. Cl. CPC F21V 5/004; B64D 11/00; F21W 2107/30; F21Y 2113/10

(57) ABSTRACT

An aircraft lamp of the present disclosure includes a plurality of LEDs, an inner lens that diffuses light of the LED in a lamp longitudinal direction, and a light scattering and transmitting member (outer lens 4) that scatters and transmits the light that transmits the inner lens. The inner lens is a cylindrical lens, and convex portions are formed along a lamp transverse direction. In addition, the convex portions are formed in parallel in a lamp longitudinal direction.

### CROSS-REFERENCE TO RELATED APPLICATION(S)

This application is based on and claims priority under 35 USC 119 from Japanese Patent Application No. 2023-023249 filed on Feb. 17, 2023, the contents of which are incorporated herein by reference.

### TECHNICAL FIELD

The present disclosure relates to an aircraft lamp used mainly in an aircraft.

### BACKGROUND ART

In the related art, a technique is known in which a light source that emits light of a plurality of different colors is arranged in a lamp chamber in an aircraft lamp used inside an aircraft, and illumination of different colors is performed according to situations or applications.

### CITATION LIST

### Patent Literature

Patent Literature 1: JP2022-134161A

However, according to an aircraft lamp in the related art, as shown in FIGS. 4A and 4B, only an area where the light source is disposed shines strongly, and brightness gradually decreases as a distance from the light source increases. Therefore, for example, in a case where the aircraft lamp is used as an indicator lamp that indicates a predetermined message, there is a problem in that a deviation occurs in a lighting manner on the entire indication surface (a front surface of the lamp), and design and visibility are deteriorated.

### SUMMARY

Accordingly, an object of the present disclosure is to provide an aircraft lamp capable of reducing a deviation in the lighting manner of the entire front surface of the lamp regardless of an arrangement of the light sources.

In order to solve the above problems, an aircraft lamp of the present disclosure has the following features.
(1) The aircraft lamp includes a plurality of light sources; a lens configured to diffuse light from the light sources; and a light scattering and transmitting member configured to scatter and transmit the light that passes through the lens, in which a plurality of substantially semi-cylindrical convex portions are formed in parallel on a light incident surface of the lens.
(2) In the case of (1), at least one of the plurality of light sources emits light in a predetermined color different from that of the other light sources.
(3) In the case of (1), the convex portions are formed along a transverse direction of the aircraft lamp and are formed in parallel in a longitudinal direction of the aircraft lamp.
(4) In the case of (1), an interval between vertices of adjacent convex portions is 0.1 mm or more and 1 mm or less.

According to the aircraft lamp of the present disclosure, since the light of the light sources is diffused more to the substantially semi-cylindrical convex portions and further scattered by the light scattering and transmitting member, the light of the light sources may spread over the entire front surface of the lamp, and deviation in a lighting manner of the entire front surface of the lamp can be reduced.

### BRIEF DESCRIPTION OF DRAWINGS

FIG. 1 is an exploded perspective view of an aircraft lamp according to an embodiment of the present disclosure.

FIG. 2A is a cross-sectional view taken along line A-A of the aircraft lamp of FIG. 1, and FIG. 2B is a cross-sectional view taken along line B-B of the aircraft lamp of FIG. 1.

FIG. 3 is a schematic diagram showing a function of a cylindrical lens.

FIGS. 4A and 4B are schematic diagrams showing a function of a configuration in the related art, and FIGS. 4C and 4D are schematic diagrams showing a function of a configuration in which the cylindrical lens is used.

FIG. 5 is a schematic diagram showing functions of the cylindrical lens and a light scattering and transmitting member.

FIGS. 6A and 6B are schematic diagrams showing a function of a configuration in which the cylindrical lens and an outer lens in the related art are used, and FIGS. 6C and 6D are schematic diagrams showing a function of a configuration in which the cylindrical lens and the light scattering and transmitting member are used.

### DESCRIPTION OF EMBODIMENTS

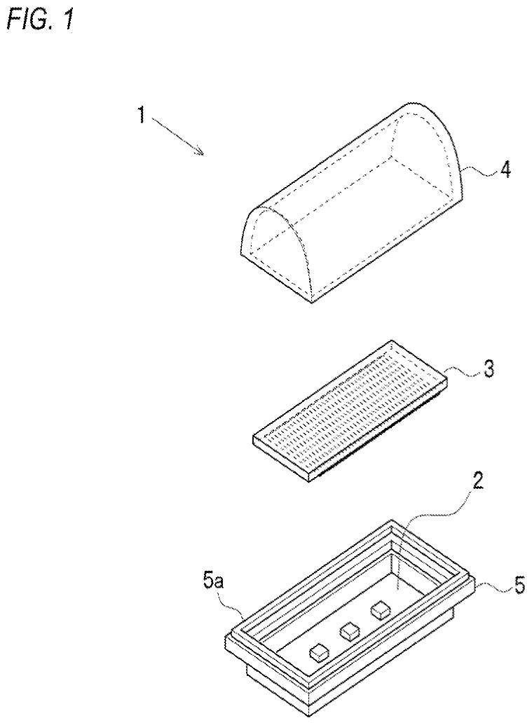

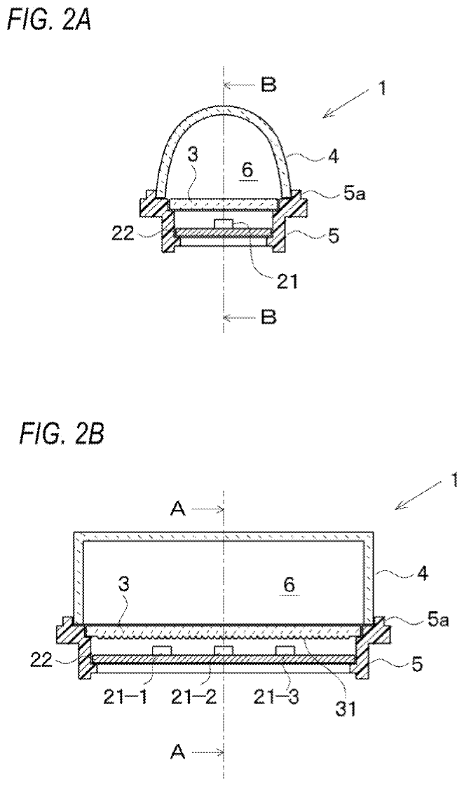

Hereinafter, an embodiment in which the present disclosure is embodied as an aircraft lamp will be described with reference to the drawings. In the following description, a side on which an outer lens 4 is arranged is referred to as a front surface side of a lamp. An aircraft lamp 1 shown in FIGS. 1 to 2B is a lamp used for an indicator lamp such as an attendant call, an interior lamp, or the like of an aircraft, and includes a lamp body 5 attached to an aircraft body and an outer lens 4, and an inner lens 3 and a light source unit 2 are accommodated in a lamp chamber 6 formed between the lamp body 5 and the outer lens 4. The lamp body 5 is provided with a projection 5a for preventing leakage of light from a peripheral portion of the outer lens 4.

The light source unit 2 includes a base 22 and a plurality of light sources (LEDs 21). Each of LEDs 21-1 to 21-3 is arranged in a lamp longitudinal direction and emits light of a different predetermined color. In this example, the LED 21-1 emits blue light, the LED 21-2 emits pink light, and the LED 21-3 emits amber light, and types of light colors of the LEDs 21, the number of LEDs 21, and an arrangement order can be changed as appropriate.

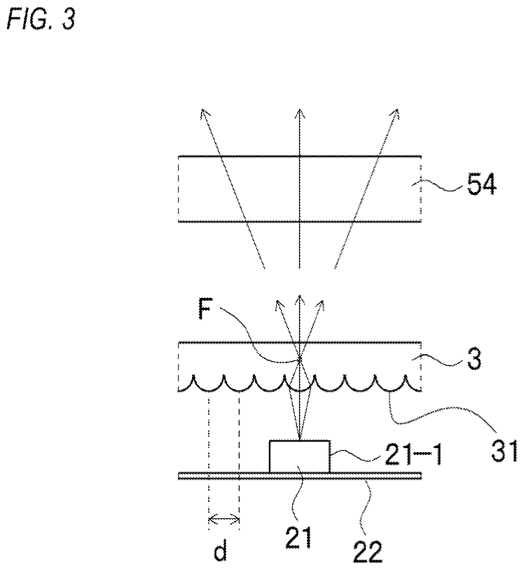

The inner lens 3 is a cylindrical lens formed by forming a plurality of semi-cylindrical convex portions 31 having fine steps in parallel. The convex portions 31 are formed along a lamp transverse direction and arranged in parallel in the lamp longitudinal direction. Further, the inner lens 3 is attached so that the convex portions 31 face the LEDs 21. Light (arrow) emitted from the LEDs 21 and incident on the convex portions 31 is temporarily aggregated toward a semi-cylindrical tube axis direction, and is diffused toward a tube radial direction after passing through a focal point F (see FIG. 3). An interval of steps d (an interval between vertices of adjacent convex portions 31) is preferably about 0.1 mm to 1 mm.

The outer lens 4 is a light scattering and transmitting member. As shown in FIG. 2A, the outer lens 4 is provided with a substantially U-shaped cross section. The light scattering and transmitting member may be made of any material that allows light to be transmitted and scattered, and for example, a resin material such as milky white polycarbonate can be used. At this time, it is also possible to provide dark eyelets (thick eyelets) to further increase a degree of light diffusion. As the light scattering and transmitting member, it is also possible to use a transparent resin member whose surface is sandblasted.

Next, functions of the inner lens 3 and the outer lens 4 in the aircraft lamp 1 formed as described above will be explained with reference to FIGS. 3 to 6D. Here, the LED 21-1 will be described as an example, and the same applies to the LEDs 21-2 and 21-3.

As shown in FIG. 3, when the inner lens 3 is formed of the cylindrical lens and the outer lens 54 formed of a light transmitting member of the related art is used, light emitted from the LED 21-1 is collected by the convex portion 31 of the inner lens 3, is diffused in the lamp longitudinal direction through the focal point F inside the inner lens 3, transmits the outer lens 4, and is emitted forward of the lamp.

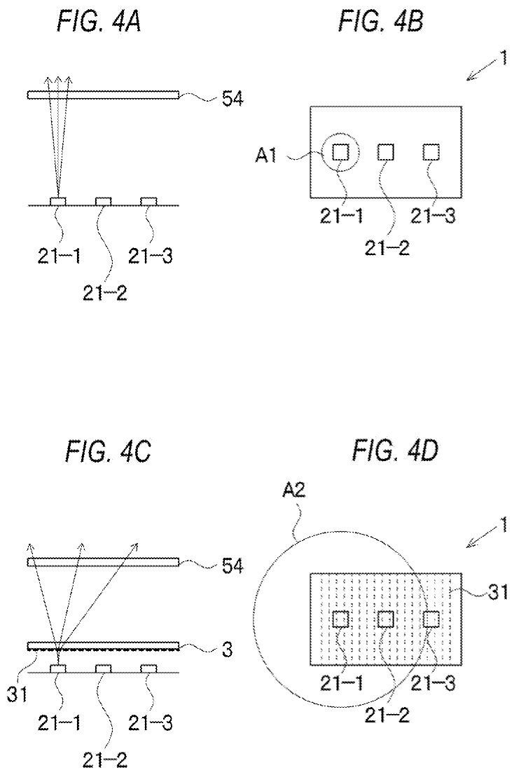

As shown in FIGS. 4A and 4B, when only the outer lens 54 formed of the light transmitting member of the related art is used, the light emitted from the LED 21-1 travels straight and transmits the outer lens 54 to illuminate an area A1. As shown in FIGS. 4C and 4D, when the inner lens 3 formed of the cylindrical lens is added, the light emitted from the LED 21-1 is diffused in the lamp longitudinal direction when transmitting the inner lens 3, transmits the outer lens 4, and illuminates an area A2 wider than the area A1. In this way, when the inner lens 3 is formed of the cylindrical lens, the entire front surface of the aircraft lamp 1 can be made to emit light more uniformly.

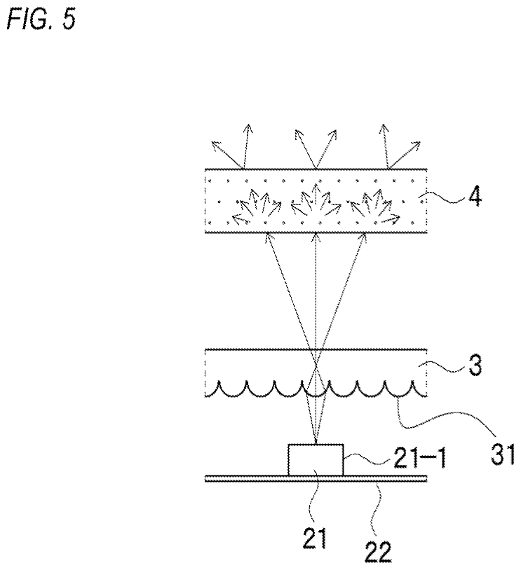

As shown in FIG. 5, when the inner lens 3 is formed of the cylindrical lens and the outer lens 4 is formed of the light scattering and transmitting member, the light emitted from the LED 21-1 and diffused to both sides by the inner lens 3 is further scattered inside the outer lens 4 and is emitted forward of the lamp.

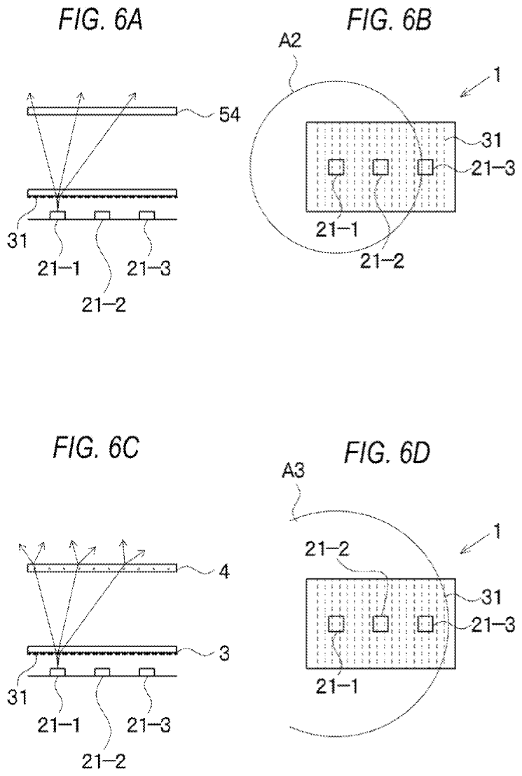

As shown in FIGS. 6A and 6B, when the inner lens 3 formed of the cylindrical lens and the outer lens 54 formed of the light transmitting member of the related art are used, the area A2 is illuminated. As shown in FIGS. 6C and 6D, when the inner lens 3 is formed of the cylindrical lens and further the outer lens 4 is formed of the light scattering and transmitting member, the light emitted from the LED 21-1 and diffused in the lamp longitudinal direction by the inner lens 3 is further scattered inside the outer lens 4 and illuminate an area A3 further wider than the area A2. In this way, when the inner lens 3 is formed of the cylindrical lens and the outer lens 4 is formed of the light scattering and transmitting member, the entire front surface of the aircraft lamp 1 can be made to emit light further uniformly.

Therefore, according to the aircraft lamp 1 of this embodiment, the substantially semi-cylindrical convex portions 31 are formed in parallel in the lamp longitudinal direction along the lamp transverse direction in the inner lens 3, and thus the light of the LEDs 21 can be directed in the lamp longitudinal direction. Since the light scattering and transmitting member is used in the outer lens 4, the light incident on the outer lens 4 can be scattered, and the aircraft lamp 1 can emit light more uniformly. In the case where a light source capable of emitting mixed light of RGB is used, since each of RGB current values changes according to a temperature, there is also a problem that a color balance is lost and reproducibility of emission color is lost, but each of the LEDs 21-1 to 21-3 emits light in a predetermined color, and thus it is possible to illuminate in a stable color even in an aircraft in which disturbance is likely to occur in power supply.

The present disclosure is not limited to the above-described embodiment, and the shape and configuration of each unit can be appropriately changed and implemented without departing from the gist of the present disclosure.

1. An aircraft lamp comprising:
a plurality of light sources;
a lens configured to diffuse light from the light sources; and
a light scattering and transmitting member configured to scatter and transmit the light that passes through the lens, wherein
a plurality of substantially semi-cylindrical convex portions are formed in parallel on a light incident surface of the lens.

2. The aircraft lamp according to claim 1, wherein
at least one of the plurality of light sources emits light in a predetermined color different from that of the other light sources.

3. The aircraft lamp according to claim 1, wherein
the convex portions are formed along a transverse direction of the aircraft lamp and are formed in parallel in a longitudinal direction of the aircraft lamp.

4. The aircraft lamp according to claim 1, wherein
an interval between vertices of adjacent convex portions is 0.1 mm or more and 1 mm or less.
